(19) United States
(12) Patent Application Publication
(10) Pub. No.: US 2026/0332393 A1
(43) Pub. Date: Oct. 22, 2026

(54) USER CONSENT MANAGEMENT IN A WIRELESS NETWORK

(71) Applicant: Lenovo (United States) Inc., Morrisville, NC (US)

(72) Inventors: Andreas Kunz, Ladenburg (DE); Sheeba Backia Mary Baskaran, Friedrichsdorf (DE); Souvik Paul, Bad Homburg (DE)

(73) Assignee: Lenovo (United States) Inc., Morrisville, NC (US)

(21) Appl. No.: 19/320,437

(22) Filed: Sep. 5, 2025

(51) Int. Cl. H04L 9/08

(52) U.S. Cl. CPC H04L 9/0825; H04L 9/0894

(57) ABSTRACT

Various aspects of the present disclosure relate to user consent (UC) in a wireless network. A user equipment (UE) receives a request for UC information associated with the UE. In some examples, the request includes a list of purposes for collecting or processing data. The UE generates a signature based on a public key, a secret key, header information, and one or more messages. In some examples, the one or more messages includes an indication of a respective purpose of the list of purposes and an indication of whether a user of the UE consents to the respective purpose. The UE transmits, based on the request, a response including the public key, the header information, the one or more messages, and the signature.

### TECHNICAL FIELD

The present disclosure relates to wireless communications, and more specifically to user consent (UC) in a wireless network.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements. The device (e.g., NE or UE), processors, and methods of the present disclosure each have several innovative aspects, no single of which is solely responsible for the desirable features disclosed herein.

A UE for wireless communication is described. The UE may be configured to, capable of, or operable to perform one or more operations as described herein. For example, the UE may be configured to, capable of, or operable to receive a request for UC information associated with the UE, the request including a list of purposes for collecting or processing data, generate a signature based on a public key, a secret key, header information, and one or more messages including an indication of a respective purpose of the list of purposes and an indication of whether a user of the UE consents to the respective purpose, and transmit, based on the request, a response including the public key, the header information, the one or more messages, and the signature.

A processor (e.g., a standalone processor chipset, or a component of the UE) for wireless communication is described. The processor may be configured to, capable of, or operable to perform one or more operations as described herein. For example, the processor may be configured to, capable of, or operable to receive a request for UC information associated with the UE, the request including a list of purposes for collecting or processing data, generate a signature based on a public key, a secret key, header information, and one or more messages including an indication of a respective purpose of the list of purposes and an indication of whether a user of the UE consents to the respective purpose, and transmit, based on the request, a response including the public key, the header information, the one or more messages, and the signature.

A method performed or performable by a UE for wireless communication is described. The method may include receiving a request for UC information associated with the UE, the request including a list of purposes for collecting or processing data, generating a signature based on a public key, a secret key, header information, and one or more messages including an indication of a respective purpose of the list of purposes and an indication of whether a user of the UE consents to the respective purpose, and transmitting, based on the request, a response including the public key, the header information, the one or more messages, and the signature.

In some implementations, the UE, the processor, and the method may further be configured to, capable of, or operable to generate the secret key based on a secret input key material (IKM) and generate the public key based on the secret key. In some implementations, the UE, the processor, and the method may further be configured to, capable of, or operable to display, via a graphical user interface (GUI) of the UE, the list of purposes to the user of the UE and receive, from the user, user input indicating whether the user of the UE consents to each purpose of the list of purposes.

In some implementations, the UE, the processor, and the method may further be configured to, capable of, or operable to generate the header information, where the header information includes an indication of a quantity of purposes included in the list of purposes and a time associated with generating the signature. In some implementations, the one or more messages further include an indication of a permanent subscriber identity (ID) associated with the UE. In some implementations, the list of purposes includes collecting or processing data for location determination, analytics, artificial intelligence (AI) model training, AI inference, location retrieval, or user information exposure.

A UE for wireless communication is described. The UE may be configured to, capable of, or operable to perform one or more operations as described herein. For example, the UE may be configured to, capable of, or operable to receive, based on a request for credentials, a response including one or more messages, first header information, a public key, and a signature, the one or more messages including an indication of a respective purpose of a list of purposes for collecting or processing data, generate a proof based on a message of the one or more messages, a secret key, the signature, and second header information, the message including an indication of a respective purpose of the list of purposes that a user of the UE consents to, and transmit a signal including the message, the second header information, and the proof.

A processor (e.g., a standalone processor chipset, or a component of the UE) for wireless communication is described. The processor may be configured to, capable of, or operable to perform one or more operations as described herein. For example, the processor may be configured to, capable of, or operable to receive, based on a request for credentials, a response including one or more messages, first header information, a public key, and a signature, the one or more messages including an indication of a respective purpose of a list of purposes for collecting or processing data, generate a proof based on a message of the one or more messages, a secret key, the signature, and second header information, the message including an indication of a respective purpose of the list of purposes that a user of the UE consents to, and transmit a signal including the message, the second header information, and the proof.

A method performed or performable by a UE for wireless communication is described. The method may include receiving, based on a request for credentials, a response including one or more messages, first header information, a public key, and a signature, the one or more messages including an indication of a respective purpose of a list of purposes for collecting or processing data, generating a proof based on a message of the one or more messages, a secret key, the signature, and second header information, the message including an indication of a respective purpose of the list of purposes that a user of the UE consents to, and transmitting a signal including the message, the second header information, and the proof.

In some implementations, the UE, the processor, and the method may further be configured to, capable of, or operable to display, via a GUI of the UE, the list of purposes to the user of the UE and receive, from the user, user input indicating whether the user of the UE consents to each purpose of the list of purposes. In some implementations, the response further includes an indication of a permanent subscriber ID associated with the UE.

In some implementations, the UE, the processor, and the method may further be configured to, capable of, or operable to compute a commitment C over the permanent subscriber ID using a hash-based commitment or a Pederson commitment. In some implementations, the signal further includes the commitment C in the second header information.

In some implementations, the second header information includes a time associated with generating the proof, a quantity of nondisclosed purposes, domain information, a quantity of purposes included in the list of purposes, and a time associated with generating the signature. In some implementations, the list of purposes includes collecting or processing data for location determination, analytics, AI model training, AI inference, location retrieval, or user information exposure.

An NE (e.g., a base station) for wireless communication is described. The NE may be configured to, capable of, or operable to perform one or more operations as described herein. For example, the NE may be configured to, capable of, or operable to transmit a request for UC information associated with a UE, the request including one or more purposes of a list of purposes for collecting or processing data, receive, based on the request, a response including one or more messages, header information, and a proof, the one or more messages including an indication of a respective purpose of the one or more purposes and an indication of whether a user of the UE consents to the respective purpose, and verify the proof based on a public key.

A processor (e.g., a standalone processor chipset, or a component of an NE) for wireless communication is described. The processor may be configured to, capable of, or operable to perform one or more operations as described herein. For example, the processor may be configured to, capable of, or operable to transmit a request for UC information associated with a UE, the request including one or more purposes of a list of purposes for collecting or processing data, receive, based on the request, a response including one or more messages, header information, and a proof, the one or more messages including an indication of a respective purpose of the one or more purposes and an indication of whether a user of the UE consents to the respective purpose, and verify the proof based on a public key.

A method performed or performable by an NE (e.g., a base station) for wireless communication is described. The method may include transmitting a request for UC information associated with a UE, the request including one or more purposes of a list of purposes for collecting or processing data, receiving, based on the request, a response including one or more messages, header information, and a proof, the one or more messages including an indication of a respective purpose of the one or more purposes and an indication of whether a user of the UE consents to the respective purpose, and verifying the proof based on a public key.

In some implementations, the header information includes a time associated with generating the proof, a quantity of undisclosed purposes, domain information, a quantity of purposes included in the list of purposes, and a time associated with generating a signature associated with the proof. In some implementations, the request further includes an indication of a permanent subscriber ID associated with the UE. In some implementations, the NE, the processor, and the method may further be configured to, capable of, or operable to detect that the one or more purposes require consent from the user prior to executing the one or more purposes.

An NE (e.g., a base station) for wireless communication is described. The NE may be configured to, capable of, or operable to perform one or more operations as described herein. For example, the NE may be configured to, capable of, or operable to transmit a request for UC information associated with a UE, the request including one or more purposes for collecting or processing data, receive, based on the request, a response including one or more messages, header information, and a proof, the one or more messages including an indication of a respective purpose of a list of purposes that a user of the UE consents to, and verify the proof based on a public key.

A processor (e.g., a standalone processor chipset, or a component of an NE) for wireless communication is described. The processor may be configured to, capable of, or operable to perform one or more operations as described herein. For example, the processor may be configured to, capable of, or operable to transmit a request for UC information associated with a UE, the request including one or more purposes for collecting or processing data, receive, based on the request, a response including one or more messages, header information, and a proof, the one or more messages including an indication of a respective purpose of a list of purposes that a user of the UE consents to, and verify the proof based on a public key.

A method performed or performable by an NE (e.g., a base station) for wireless communication is described. The method may include transmitting a request for UC information associated with a UE, the request including one or more purposes for collecting or processing data, receiving, based on the request, a response including one or more messages, header information, and a proof, the one or more messages including an indication of a respective purpose of a list of purposes that a user of the UE consents to, and verifying the proof based on a public key.

In some implementations, the header information includes a time associated with generating the proof, a quantity of undisclosed purposes, domain information, a quantity of purposes included in the list of purposes, and a time associated with generating a signature associated with the proof. In some implementations, the request further includes an indication of a permanent subscriber ID associated with the UE.

### BRIEF DESCRIPTION OF THE DRAWINGS

FIG. 1 illustrates an example of a wireless communications system in accordance with aspects of the present disclosure.

FIG. 2 illustrates an example of a wireless communications system in accordance with aspects of the present disclosure.

FIG. 3 illustrates an example of a process flow in accordance with aspects of the present disclosure.

FIG. 4 illustrates an example of a process flow in accordance with aspects of the present disclosure.

FIG. 5 illustrates an example of a GUI in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates an example of a flowchart of a method performed by a UE in accordance with aspects of the present disclosure.

FIG. 10 illustrates an example of a flowchart of a method performed by a UE in accordance with aspects of the present disclosure.

FIG. 11 illustrates an example of a flowchart of a method performed by an NE in accordance with aspects of the present disclosure.

FIG. 12 illustrates an example of a flowchart of a method performed by an NE in accordance with aspects of the present disclosure.

### DETAILED DESCRIPTION

A network (e.g., a serving network such as a roaming network or a home network) may request services that involve collecting or processing data from a UE or another device associated with a user. Such services may include collecting or processing data for purposes of location determination, AI model training, AI model inference, etc. UC associated with collecting or processing such data may be given by the user by signing a contract with a network that the UE is subscribed to (e.g., the home network). But the user may be unaware of what data is being collected or processed and for what purpose(s). Further, the user may be unable to change UC after signing the contract. Thus, it may be beneficial to develop a UC framework that allows the user to selectively modify UC for data collection or processing for specific purposes.

As described herein, a UE may receive a request for UC information associated with the UE that includes a list of purposes for collecting or processing data. In response to the request, the UE may generate a signature using a public key, a secret key, header information, and one or more messages that include an indication of a respective purpose of the list of purposes and an indication of whether a user of the UE consents to the respective purpose. After generating the signature, the UE may transmit a response to the request that includes the public key, the header information, the one or more messages, and the signature.

In another embodiment of the invention, the UE may transmit a request for credentials and in response to the request, receive a response including one or more messages, first header information, a public key, and a signature. In some examples, the one or more messages may include an indication of a respective purpose of a list of purposes for collecting or processing data. After receiving the response, the UE may generate a proof using a message of the one or more messages, a secret key, the signature, and second header information. In some examples, the messages may include an indication of the respective purpose of the list of purposes that the user of the UE consents to. The UE may then transmit a signal including the message, the second header information, and the proof.

It should be understood that various terms may be used interchangeably with “communicating,” such as “signaling,” “transmitting,” “receiving,” “outputting,” “forwarding,” “relaying,” “retrieving,” “obtaining,” and so forth.

By performing the techniques described, the wireless communications system provides a framework that allows a UE to selectively modify UC for data collection and processing.

Aspects of the present disclosure are described in the context of a wireless communications system. Additional aspects of the present disclosure are described in the context of component diagrams, process flows, method flows, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

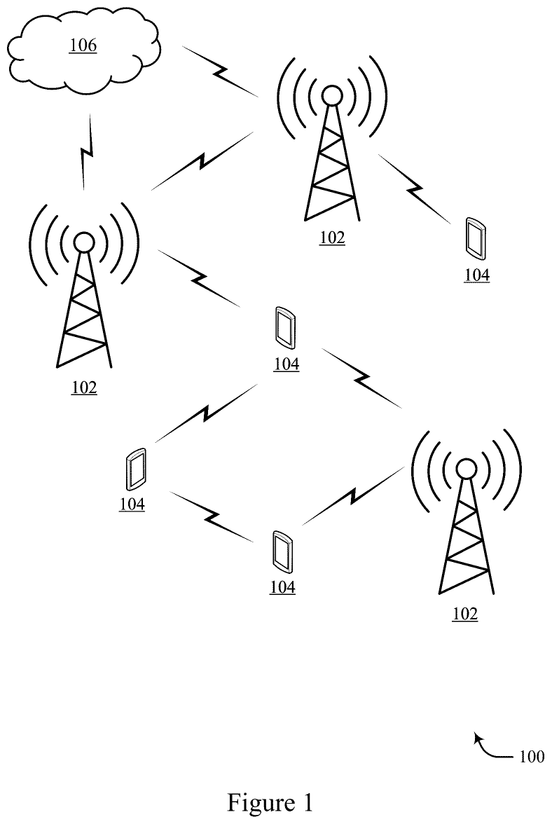

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Devices of the wireless communications system 100 (e.g., UE(s) 104 and NE(s) 102) may use a digital signature to confirm integrity of messages. The digital signature ensures that information in a message originated from a signer of the signature and was not altered during communication. Any changes to the information of the message invalidates the digital signature. In a digital signature system, there exists an issuer, a holder, and a verifier. The issuer may be described as an entity that generates the digital signature, the holder may be described as an entity that assumes possession of the digital signature, and the verifier may be described as an entity that verifies an integrity of a message using the digital signature. In some examples, the digital signature is generated using a secret key and the digital signature is verified using a corresponding public key.

A BBS signature scheme is a type of signature scheme that provides some unique properties over other signature schemes. First, the BBS signature scheme allows the issuer to sign multiple messages and produce a single output signature. The holder can then generate a proof whereby the holder can choose which messages of the multiple messages to disclose without revealing any information regarding the undisclosed messages. Second, the proof may be a zero-knowledge proof. In other words, the verifier of the proof is unable to determine which signature was used to generate the proof. Third, the proof may prove to the verifier that the holder was in possession of the signature without revealing the signature. Further, the BBS signature scheme supports binding presentation header information to the proof which acts as a message signed by the holder. The presentation header information may include arbitrary information such as a nonce, domain ID, etc. In some examples, the device may generate the BBS signature using one or more of a secret key, a public key, one or more generators, a header, an api_id parameter, and one or more messages converted into scalars.

In some examples, the UE 104 may be associated with a permanent subscriber ID (e.g., a subscription permanent ID (SUPI) or an international mobile subscriber identity (IMSI)). The permanent subscriber ID may be described as a secret parameter that identifies a subscription and is known only to the UE 104 and to the network. Because the permanent subscriber ID is secret, it may not be transmitted over-the-air (OTA) without protection (e.g., uncyphered). To protect the permanent subscriber ID, the device of the wireless communications system 100 (e.g., the UE 104 or the NE 102) may generate a commitment over the permanent subscriber ID. Traditional commitments may have the format of commitment=Hash {secret value, salt}, where the salt is a random value to prevent an attacker from guessing the secret value. Pedersen commitments may be very similar to traditional commitments, but Pedersen commitments use elliptic curve groups instead of cryptographic hash functions. Pedersen commitments also require that the secret value (e.g., the permanent subscriber ID) is converted into an integer value before the computations. A commitment may prove that a sender knows the permanent subscriber ID without revealing it.

According to implementations, one or more of the NEs 102 and the UEs 104 are operable to implement various aspects of the techniques described with reference to the present disclosure. For example, a UE 104 receives a request for UC information associated with the UE, the request including a list of purposes for collecting or processing data, generates a signature based on a public key, a secret key, header information, and one or more messages including an indication of a respective purpose of the list of purposes and an indication of whether a user of the UE consents to the respective purpose, and transmits, based on the request, a response including the public key, the header information, the one or more messages, and the signature. An NE 102 (e.g., a base station, gNB) transmits a request for UC information associated with a UE, the request including one or more purposes of a list of purposes for collecting or processing data, receives, based on the request, a response including one or more messages, header information, and a proof, the one or more messages including an indication of a respective purpose of the one or more purposes and an indication of whether a user of the UE consents to the respective purpose, and verifies the proof based on a public key.

In other implementations, one or more of the NEs 102 and the UEs 104 are operable to implement various aspects of the techniques described with reference to the present disclosure. For example, a UE 104 receives, based on a request for credentials, a response including one or more messages, first header information, a public key, and a signature, the one or more messages including an indication of a respective purpose of a list of purposes for collecting or processing data, generates a proof based on a message of the one or more messages, a secret key, the signature, and second header information, the message including an indication of a respective purpose of the list of purposes that a user of the UE consents to, and transmits a signal including the message, the second header information, and the proof. An NE 102 (e.g., a base station, gNB) transmits a request for UC information associated with a UE, the request including one or more purposes for collecting or processing data, receives, based on the request, a response including one or more messages, header information, and a proof, the one or more messages including an indication of a respective purpose of a list of purposes that a user of the UE consents to, and verifies the proof based on a public key.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

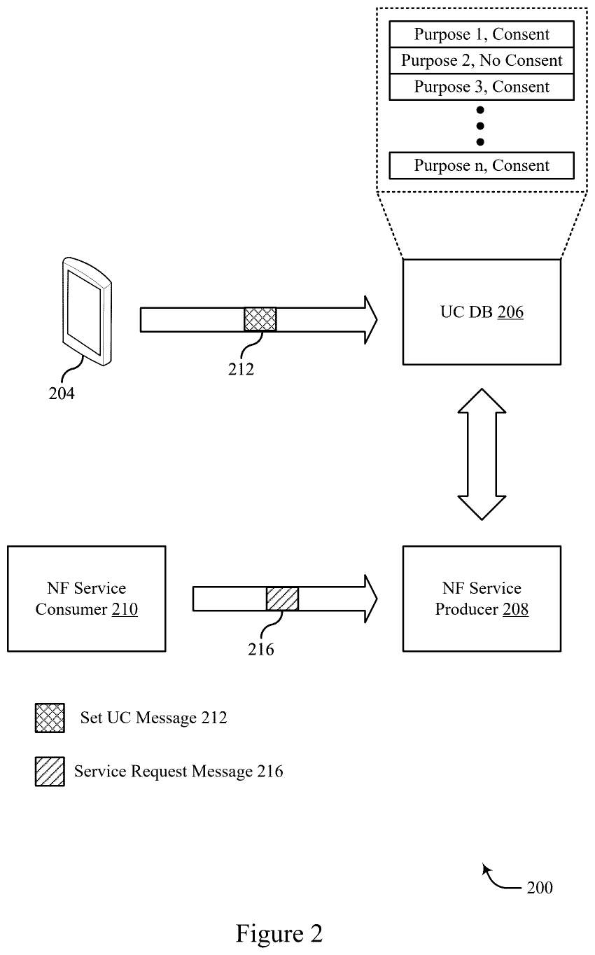

FIG. 2 illustrates an example of a wireless communications system 200 in accordance with aspects of the present disclosure. In some examples, the wireless communications system 200 may implement aspects of the wireless communications system 100. For example, the wireless communications system 200 may include a UE 204 which may be an example of the UE 104 as described with reference to FIG. 1.

The UE 204 may be in communication with a UC database (DB) 206. The UC DB 206 may be an example of a network component that is a part of a home network of the UE 204. Further, the UC DB 206 may be configured to store UC information for the UE 104. More specifically, for each UE 204, the UC DB 206 may be configured to store a list of purposes for collecting or processing data as well as a value of UC or no UC for each purpose of the list of purposes. As an example, a purpose of the list of purposes may include collecting data for location determination of the UE 104.

The UE 204 may identify whether a user of the UE 104 consents to purposes of the list of purposes and send a set UC message 212 to the UC DB 206. The set UC message 212 may include an indication of at least one purpose of the list of purposes as well as a value of UC or no UC for the at least one purpose. In the example of FIG. 2, the set UC message 212 may include an indication of Purpose 1 with a value set to consent, an indication of Purpose 2 with a value set to no consent, an indication of Purpose 3 with a value set to consent, . . . , and an indication of Purpose n with a value set to consent. In response to the set UC message 212, the UC DB 206 may store the purposes along with the values of no UC or UC in storage of the UC DB 206 as UC information corresponding to the UE 204.

The UC DB 206 may be in further communication with an NF service producer 208 which is in communication with an NF service consumer 210. The NF service producer 208 and the NF service consumer 210 may be examples of network components that are a part of a serving network of the UE 204 (e.g., the home network or a roaming network).

In some examples, the NF service consumer 210 may send a service request message 216 to the NF service producer 208 requesting that the NF service producer 208 execute a requested service. Upon receiving the service request message 216, the NF service producer 208 may check whether data collected or processed for the requested service requires UC from the UE 204. As an example, the data collected for the requested service or a purpose corresponding to the requested service may include detailed location data of the UE 204.

If the purpose corresponding to the requested service requires UC from the UE 204, the NF service producer 208 may query the UC DB 206 and determine whether UC is given for the purpose based on the UC information stored at the UC DB 206. The NF service producer 208 may perform the service in response to determining that UC is given for the purpose and transmit service data (e.g., user location data) to the NF service consumer 210. Alternatively, the NF service producer 208 may not perform the service in response to determining that UC is not given for the purpose and transmit an error message to the NF service consumer 210.

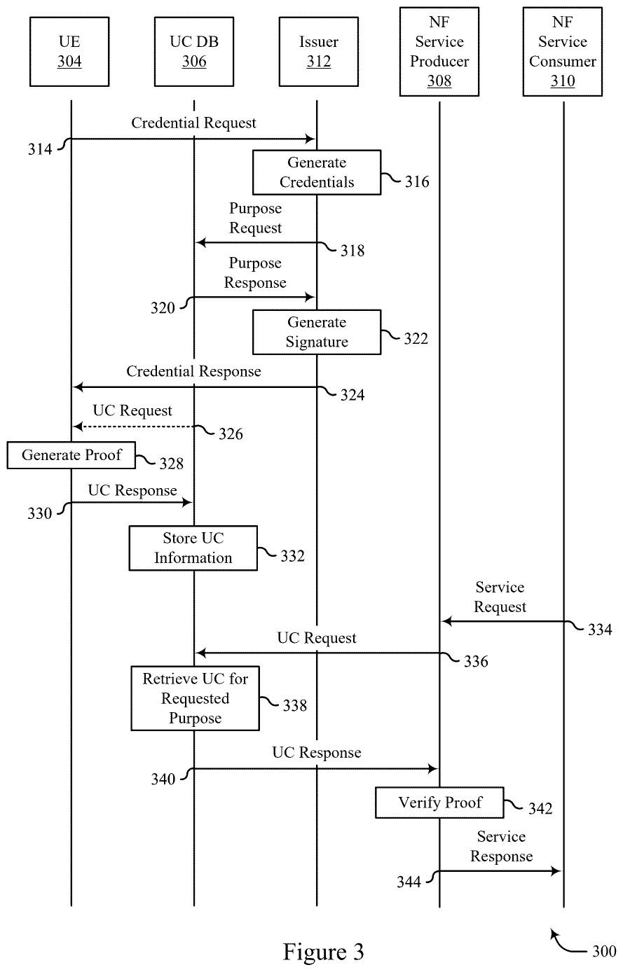

FIG. 3 illustrates an example of a process flow 300 in accordance with aspects of the present disclosure. In some examples, the process flow 300 may implement, or be implemented by, aspects of the wireless communications system 100 or the wireless communications system 200. For example, a UE 304 may be an example of the UE 104 or the UE 204 as described with reference to FIG. 1 or 2. Additionally, the UC DB 306, the NF service producer 308, and the NF service consumer 310 may be examples of the UC DB 206, the NF service producer 208, and the NF service consumer 210, respectively, as described with reference to FIG. 2.

The UC DB 306, an issuer 312, the NF service producer 308, and the NF service consumer 310 may be examples of network components. As such, the UC DB 306, the issuer 312, the NF service producer 308, and the NF service consumer 310 may be located within or connected with one or more NEs. The UC DB 306 and the issuer 312 may be part of a home network, whereas the NF service producer 308 and the NF service consumer 310 may be a part of a serving network. The serving network may be described as a network that the UE 304 connects to at any given time. The home network may be described as a network that the UE 304 is registered with or subscribed to. In some examples, the serving network and the home network may be the same. In other examples, the serving network may be an example of a roaming network.

At 314, the UE 304 may communicate (e.g., transmit or send) a credential request to the issuer 312. The credential request may request for the issuer 312 to provide credentials to the UE 304. In some examples, a connection between the UE 304 and the issuer 312 may be secure (e.g., integrity and confidentiality protected).

At 316, the issuer 312 may generate one or more credentials in response to the credential request. The one or more credentials may include a secret key and a public key. The issuer 312 may generate the secret key using a key generation method (e.g., a hashed key derivation function (HKDF)) from a secret IKM. The secret IKM may be different for each subscriber or UE 304. Further, the issuer 312 may generate the public key using the secret key as an input.

At 318, the issuer 312 may communicate (e.g., transmit or send) a purpose request to the UC DB 306. The purpose request may request for the UC DB 306 to provide a list of purposes for collecting or processing data.

At 320, the UC DB 306 may communicate (e.g., transmit or send) a purpose response to the issuer 312. The purpose response may include an indication of the list of purposes requested by the issuer 312 via the purpose request. The list of purposes may include all of the purposes defined in the network for which UC from the UE 304 is required. As an example, the list of purposes may include collecting data for location services, analytics, AI model training, AI model inference, EDGEAPP UE location retrieval, user information exposure, etc.

At 322, the issuer 312 may create a signature (e.g., a BBS signature) over all of the purposes of the list of purposes. First, the issuer 312 may generate header information. As illustrated in Table 1, the header information may include an indication of a quantity of purposes included in the list of purposes as well as a time associated with generating the signature. Second, the issuer 312 may generate a set of messages that each have a corresponding index. In some examples, some of the messages of the set of messages may include an indication of a respective purpose of the list of purposes. As illustrated in Table 1, the issuer 312 may generate a set of messages that includes a first message with index [1], a second message with index [2], a third message with index [3], a fourth message with index [4], a fifth messages with index [5], and a sixth messages with index [6]. The first message, the second message, the third message, the fourth message, the fifth message, and the sixth message may include an indication of a purpose #1, a purpose #2, a purpose #3, a purpose #4, a purpose #5, and a purpose #6, respectively. Additionally, or alternatively, some of the messages may include an indication of a permanent subscriber ID of the UE 304. For example, as illustrated in Table 1, the issuer 312 may generate a set of messages that includes a message with index [0] that includes an indication of the permanent subscriber ID of the UE 304. Upon generating the header information and the set of messages, the issuer 312 may create the signature. As shown in Table 1, the issuer 312 may create the signature using the secret key, the public key, the header information, and the set of messages as inputs. In some examples, prior to creating the signature, the issuer 312 may convert the set of messages into scalars.

TABLE 1

Header Information
# of purposes
Time of issuer signature
Set of Messages
[0] Permanent Subscriber ID
[1] Purpose #1
[2] Purpose #2
[3] Purpose #3
[4] Purpose #4
[5] Purpose #5
[6] Purpose #6
Signature (Secret Key, Public Key, Header Information, Messages)

At 324, the issuer 312 may communicate (e.g., transmit or send) a credential response to the UE 304. The credential response may include the public key, the header information, the set of messages, and the signature created by the issuer 312. Accordingly, the UE 304 may act as a holder of the signature.

At 326, the UC DB 306 may optionally communicate (e.g., send or transmit) a UC request to the UE 304. The UC request may request for the UE 304 to provide UC information for the list of purposes. Further, the UC request may include an indication of the list of purposes. In some implementations, the UC request is not needed and instead, the UE 304 may be triggered to provide the UC information for the list of purposes in response to receiving the credential response.

In response to the UC request or the credential response, the UE 304 may identify UC information for each purpose of the list of purposes. In some examples, the UE 304 may display, via a GUI of the UE 304, the list of purposes to a user of the UE 304 and receive user input indicating whether the user of the UE 304 consents to each purpose of the list of purposes. Based on the user input, the UE 304 may categorize the purposes of the list of purposes as either consent or no consent. As an example, the UE 304 may select consent for purpose #1, purpose #3, and purpose #6 of the list of purposes, and select no consent for purpose #2, purpose #4, and purpose #5 of the list of purposes.

In some examples, a connection between the UC DB 306 and the UE 304 may not be secure. In such case, the UE 304 may protect the permanent subscriber ID by creating a Commitment C over the permanent subscriber ID. The Commitment C may be computed as a traditional hash-based commitment or a Pederson commitment. In some examples, to ensure uniqueness for different commitments over the same permanent subscriber ID, the commitment computations may involve a random number parameter (e.g., salt, nonce, or freshness parameter).

At 328, the UE 304 may generate a proof over purposes with UC. First, the UE 304 may generate presentation header information. The presentation header information may include one or more of a quantity of purposes with no consent (e.g., purpose #2, purpose #4, and purpose #5=3 purposes), a time associated with generating the proof, and domain information where the subscription is located. In some examples, the UE 304 may consider the permanent subscriber ID when identifying the quantity of purposes with no consent. For example, the UE 304 may identify that the quantity of purposes with no consent is equal to the quantity of purposes with no consent plus 1 (e.g., 4). Additionally, if Commitment C is created by the UE 304, the presentation header information may further include an indication of Commitment C as well as an indication of the random number parameter used to create Commitment C. The UE 304 may generate the proof using a function (e.g., CoreProofGen). As shown in Table 2, inputs to the function may include one or more of the secret key, the signature, one or more generators, the header information, the presentation header information, one or more messages of the set of messages converted into scalars, indexes of messages with consent, or an api_id parameter. If the connection is secure between the UE 304 and the UC DB 306, the UE 304 may not compute the Commitment C over the permanent subscriber ID and the inputs to the function may further include the permanent subscriber ID (e.g., as part of the one or more messages), but may not include any information related to Commitment C.

TABLE 2
Presentation Header Information
Time of proof generation
# of purposes with no consent
Domain information
Commitment C
Random number parameter
Header Information
# of purposes
Time of issuer signature
Set of Messages
[1] Purpose #1
[3] Purpose #3
[6] Purpose #6
Proof (Signature, Secret Key, Header Information, Presentation Header
Information, Messages)

At 330, the UE 304 may communicate (e.g., transmit or send) a UC response to the UC DB 306. The UC response may include one or more messages that indicate purposes with consent, the presentation header information, the header information, and the proof. As shown in Table 2, the purposes with consent may include purpose #1, purpose #3, and purpose #6. If the connection is secure between the UE 304 and the UC DB 306, the UC response may also include an indication of the permanent subscriber ID as a message.

At 332, the UC DB 306 verifies the proof and stores the UC information in storage of the UC DB 306. For example, the UC DB 306 marks disclosed purposes (e.g., purpose #1, purpose #3, and purpose #6) with consent and the undisclosed purposes (e.g., purposes #2, purpose #4, and purpose #6) with no consent and stores this information as the UC information. The UC DB 306 may also store the header information or the presentation header information. UC DB 306 may be unable to alter the disclosed and undisclosed purposes and their corresponding consent information because they are cryptographically bound to the proof. Further, the UC DB 306 may verify the Commitment C if included in the UC response. In some examples, the UC DB 306 may communicate (e.g., transmit or send) an acknowledgement message to the UE 404 confirming that the UC DB 306 obtained the UC information.

At 334, the NF service consumer 310 may communicate (e.g., transmit or send) a service request to the NF service producer 308. The service request may request that the NF service producer 308 provide UC information for a particular service which corresponds to a respective purpose. For example, the service request may request for the NF service producer to provide location information associated with the UE 304. In some examples, the service request may include an indication of the permanent subscription ID associated with the UE 304.

Upon receiving the service request from the NF service consumer 310, the NF service producer 308 may identify whether UC needs to be considered before executing the service requested by the NF service consumer 310. That is, the NF service producer 308 identifies the purpose corresponding to the service and determines whether the purpose is included in the list of purposes. If the NF service producer 308 identifies that UC needs to be considered, the NF service producer may communicate (e.g., transmit or send) a UC request to the UC DB 306 at 336. The UC request may request UC information for the requested purpose. In some examples, the UC request may include an index associated with the requested purpose as well as an indication of the permanent subscription ID associated with the UE 304.

At 338, the UC DB 306 may retrieve the UC information associated with the UE 304. In some examples, the UC information may indicate that the requested purpose has consent. Alternatively, the UC information may indicate that the requested purpose does not have consent.

At 340, the UC DB 306 may transmit a UC response to the NF service producer 308. The UC response may include one or more of an indication of the purposes with consent (e.g., purpose #1, purpose #3, and purpose #6), the presentation header information, the header information, or the proof.

In some examples, the UC DB 306 may not transmit the UC response message. Instead, if the UC DB 306 determines that the requested purpose is not included in the disclosed purposes (e.g., the purposes with consent), the UC DB 306 may communicate (e.g. transmit or send) a negative message to the NF service producer 308 that only indicates that no UC is given for the requested purpose.

At 342, the NF service producer 308 may verify the proof included in the UC response using the public key and obtain the information included in the UC response (e.g., the indication of the purposes with consent, the presentation header information (e.g., Commitment C or the random number parameter associated with Commitment C), or the header information). If the purposes with consent do not include the requested purpose, the NF service producer 308 may assume that the requested purpose does not have consent and vice versa. Further, the NF service producer 308 may verify the Commitment C to ensure that the UC information originated at the UE 304. Accordingly, the NF service producer 308 may act as a verifier of the signature.

If the NF service producer 308 determines that the requested purpose has consent, the NF service producer 308 may execute the requested service and communicate (e.g., transmit or send) a service response to the NF service consumer 310 that includes service data corresponding to the service at 344. Alternatively, the NF service producer 308 may not execute the requested service if the NF service producer 308 determines that the requested purpose does not have consent and communicate the service response to the NF service consumer 310 that includes an error or failure message.

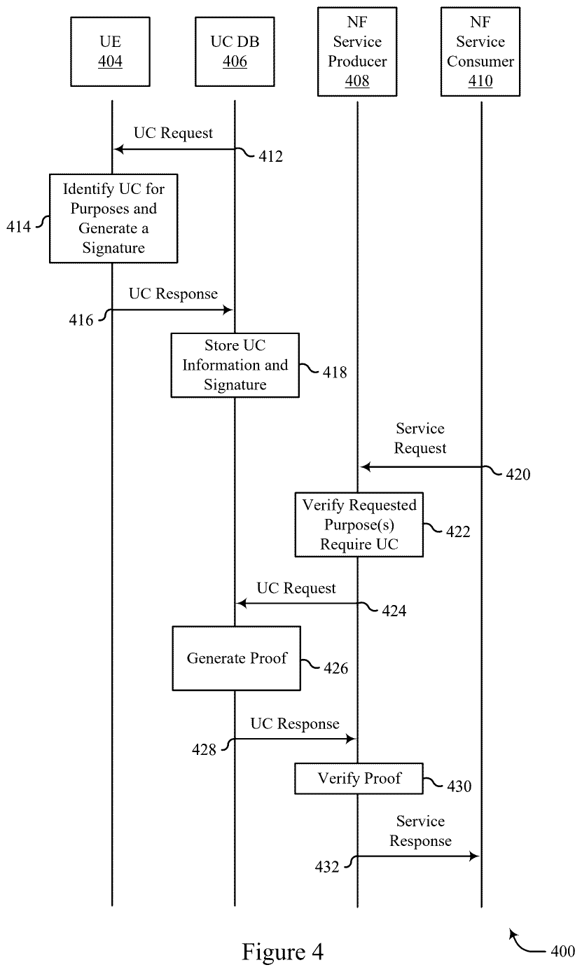

FIG. 4 illustrates an example of a process flow 400 in accordance with aspects of the present disclosure. In some examples, the process flow 400 may implement, or be implemented by, aspects of the wireless communications system 100 or the wireless communications system 200. For example, a UE 404 may be an example of the UE 104 or the UE 204 as described with reference to FIG. 1 or 2. Additionally, the UC DB 406, the NF service producer 408, and the NF service consumer 410 may be examples of the UC DB 206, the NF service producer 208, and the NF service consumer 210, respectively, as described with reference to FIG. 2.

The UC DB 406, the NF service producer 408, and the NF service consumer 410 may be examples of network components. That is, the UC DB 406, the NF service producer 408, and the NF service consumer 410 may be located within or connected with one or more NEs. The UC DB 406 may be part of a home network, whereas the NF service producer 408 and the NF service consumer 410 may be a part of a serving network. The serving network may be described as a network that the UE 404 connect to at any given time. The home network may be described as a network that the UE 404 is registered with or subscribed to. In some examples, the serving network and the home network may be the same. In other examples, the serving network may be an example of a roaming network.

At 412, the UC DB 406 may communicate (e.g., transmit or send) a UC request to the UE 404. The UC request may request for the UE 404 to provide UC information for each purpose of a list of purposes. In some examples, the UC request may include an indication of the list of purposes. The list of purpose may include all of the purposes defined in the network for which UC from the UE 404 is required. As an example, the list of purposes may include collecting data for location services, analytics, AI model training, AI model inference, EDGEAPP UE location retrieval, user information exposure, etc.

At 414, the UE 404 may identify UC information for each purpose of the list of purposes and generate a signature (e.g., a BBS signature). The UE 404 may generate one or more credentials. The one or more credentials may include a secret key and a public key. The UE 404 may generate the secret key using a key generation method (e.g., a hashed key derivation function (HKDF)) from an IKM. The secret IKM may be different for each UE 404 and may be preconfigured or randomly generated at the UE 404. Further, the UE 404 may generate the public key using the secret key as an input.

Further, the UE 404 may display, via a GUI of the UE 404, the list of purposes to a user of the UE 404 and receive user input indicating whether the user of the UE 404 consents to each purpose of the list of purposes. Based on the user input, the UE 304 may categorize the purposes of the list of purposes as either consent or no consent. As an example, the UE 404 may select consent for purpose #1, purpose #3, and purpose #6 of the list of purposes, and select no consent for purpose #2, purpose #4, and purpose #5 of the list of purposes. Moreover, the UE 404 may generate a set of messages that each have a corresponding index. In some examples, some of the messages of the set of messages may include an indication of a respective purpose of the list of purposes as well as consent information (e.g., consent or no consent) for the respective purpose. As illustrated in Table 3, the UE 404 may generate a set of messages that include a first message with index [1], a second message with index [2], a third message with index [3], a fourth message with index [4], a fifth messages with index [5], and a sixth messages with index [6], where the first message, the second message, the third message, the fourth message, the fifth message, and the sixth message include an indication of a purpose #1, a purpose #2, a purpose #3, a purpose #4, a purpose #5, and a purpose #6, respectively, of the list of purposes and a consent value (e.g., consent or no consent). Additionally, or alternatively, some of the messages may include an indication of a permanent subscriber ID of the UE 404. For example, as illustrated in Table 3, the UE 404 may generate a set of messages that includes a message with index [0] that includes an indication of the permanent subscriber ID of the UE 404.

Further, the UE 404 may generate header information. As illustrated in Table 3, the header information may include an indication of a quantity of purposes included in the list of purposes as well as a time associated with generating the signature. Upon generating the header information and the set of messages, the UE 404 may create the signature. As shown in Table 3, the UE 404 may create the signature using a secret key, the public key, the header information, and the set of messages as inputs. In some examples, prior to creating the signature, the UE 404 may convert the set of messages into scalars.

TABLE 3

Header Information
# of purposes
Time of issuer signature
Set of Messages
[0] Permanent Subscriber ID
[1] Purpose #1, Consent
[2] Purpose #2, No Consent
[3] Purpose #3, Consent
[4] Purpose #4, No Consent
[5] Purpose #5, No Consent
[6] Purpose #6, Consent
Signature (Secret Key, Public Key, Header Information, Messages)

At 416, the UE 404 may communicate (e.g., send or transmit) a UC response to the UC DB 406. The UC response may include the set of messages, an indication of the header information, the public key, and the signature created by the UE 404. Accordingly, the UE 404 may act as the issuer of the signature while the UC DB 406 may act as the holder of the signature.

At 418, the UC DB 406 stores the UC information in storage of the UC DB 406. For example, the UC DB 406 marks purposes as consent or no consent and stores this information as the UC information associated with the UE 404. The UC DB 406 may also store one or more of the header information or the presentation header information. The UC DB 406 may be unable to alter the purposes and their corresponding consent information because they are cryptographically bound in the signature from the UE 404.

At 420, the NF service consumer 410 may communicate (e.g., transmit or send) a service request to the NF service producer 408. The service request may request that the NF service producer 408 provides UC information for a particular service corresponding to a respective purpose. For example, the service request may request the NF service producer 408 to provide location information associated with the UE 404. In some examples, the service request may include an indication of the permanent subscriber ID associated with the UE 404.

Upon receiving the service request from the NF service consumer 410, the NF service producer 408 may verify whether UC needs to be considered before executing the service requested by the NF service consumer 410 at 422. That is, the NF service producer 408 identifies the respective purpose corresponding to the requested service and determines whether the respective purpose is included in the list of purposes. If the NF service producer 408 identifies that UC needs to be considered, the NF service producer 408 may communicate (e.g., transmit or send) a UC request to the UC DB 406 at 424. The UC request may request UC information for the respective purpose. In some examples, the UE request may include an index associated with the respective purpose as well as an indication of the permanent subscriber ID associated with the UE 404. As an example, the respective purpose may correspond to purpose #1.

At 426, the UC DB 406 may generate a proof over the respective purpose. First, the UC DB 406 may generate presentation header information. The presentation header information may include one or more of a quantity of undisclosed purposes (e.g., purpose #2, purpose #3, purpose #4, purpose #5, purpose #6=5 purposes), a time associated with generating the proof, and domain information where the subscription is located. The UC DB 406 may generate the proof using a function (e.g., CoreProofGen). As shown in Table 4, inputs to the function may include one or more of the secret key, the signature, one or more generators, the header information, the presentation header information, one or more messages of the set of messages converted into scalars, indexes of disclosed message(s) (e.g., index of purpose #1), or an api_id parameter.

TABLE 4
Presentation Header Information
Time of proof generation
# of undisclosed purposes
Domain information
Header Information
# of purposes
Time of issuer signature
Set of Messages
[0] Permanent Subscriber ID
[1] Purpose #1, Consent
Proof (Signature, Secret Key, Header Information, Presentation Header
Information, Messages)

At 428, the UC DB 406 may communicate (e.g., transmit or send) a UC response to the NF service producer 408. The UC response may include an indication of the header information, the presentation header information, the proof, and the one or more messages of the set of messages (e.g., the message that indicates the permanent subscriber ID (e.g., [0] Permanent Subscriber ID) as well as the message that indicates the respective purpose and its corresponding consent value (e.g., [1] purpose #1, consent)).

At 430, the NF service producer 408 verifies the proof included in the UC response using the public key and obtains the information included in the UC response (e.g., the consent information corresponding to the respective purpose, the presentation header information, and the header information). Further, the NF service producer 408 verifies whether the UC is granted for the respective purpose for the requested service. Accordingly, the NF service producer 408 acts as the verifier of the signature.

If the NF service producer 408 determines that the respective purpose has consent, the NF service producer 408 may execute the requested service and communicate a service response to the NF service consumer 410 that includes service data corresponding to the service at 432. Alternatively, the NF service producer 408 may not execute the requested service if the NF service producer 408 determines that the respective purpose does not have consent and communicate the service response to the NF service consumer 410 that includes an error or failure message.

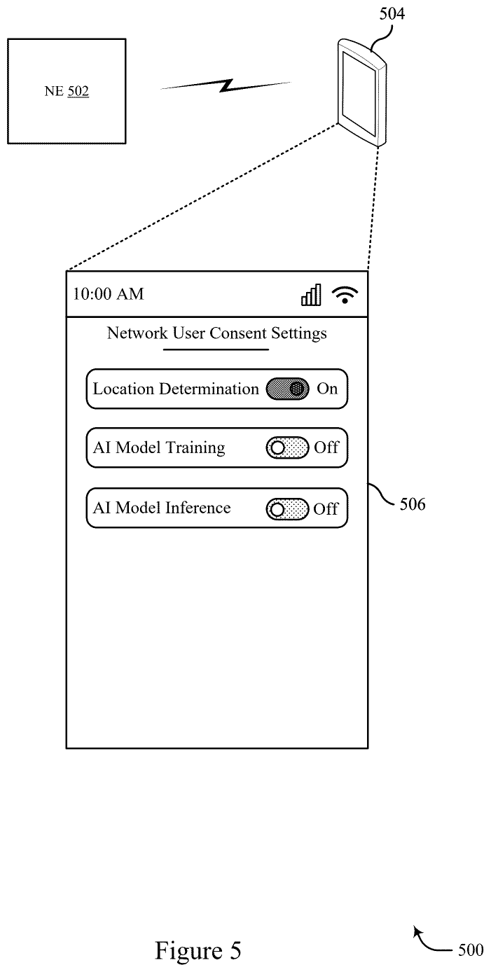

FIG. 5 illustrates an example of GUI 500 in accordance with aspects of the present disclosure. The GUI 500 may implement, or be implemented by, aspects of the wireless communications system 100 and the wireless communications system 200. For example, the GUI 500 may be implemented by the UE 104 or the UE 204 as described with reference to FIGS. 1 and 2. The GUI 500 may illustrate a series of application pages 506 which may be displayed to a user via the GUI 500.

As described with reference to FIG. 1, a UE 504 associated with a user may establish a communication link with an NE 502. In some examples, the NE 502 may provide, via the communication link, a list of purposes for collecting or processing data. For example, the list of purposes may include collecting data for location determination, AI model generation, or AI model inference. Upon receiving the list of purposes, the UE 504 may generate a visual list of the purposes for display on the GUI 500. Next to each purpose, the UE 504 may generate a UI element that prompts the user of the UE 504 to choose between consent or no consent for each purpose of the list.

In the example of FIG. 5, the UE 504 may generate a toggle next to each purpose. A toggle in the “on” position may indicate consent for the corresponding purpose whereas a toggle in the “off” position may indicate no consent for the corresponding purpose. As illustrated in FIG. 5, the toggle corresponding to location determination is toggled to the “on” position and the toggles for AI Model Training and AI Model Interference are toggled to the “off” position. To change the position of the toggle, the user may physically interact (e.g., touch) the toggle displayed on the GUI 500. Using this user input, the UE 504 may determine whether the user provides consent for each purpose included in the list of purposes.

To access the list of purposes, the user may open an application (e.g., system settings application). An application page 506 of the application may display the list of purposes. As an example, a title of the application page 506 may be “Network User Consent Settings.”

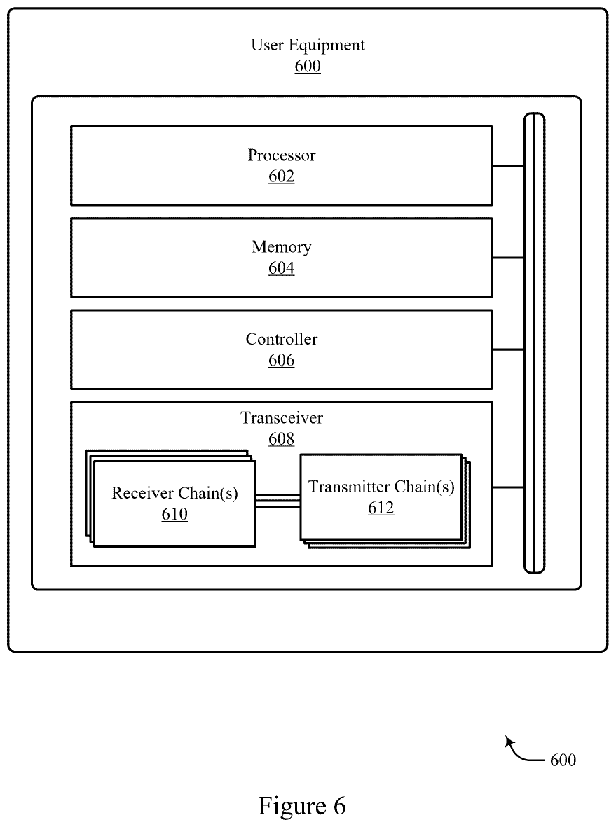

FIG. 6 illustrates an example of a UE 600 in accordance with aspects of the present disclosure. In some examples, the UE 600 may be an example of a UE as described with reference to FIGS. 1 through 4. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving a request for UC information associated with the UE, the request including a list of purposes for collecting or processing data, generating a signature based on a public key, a secret key, header information, and one or more messages including an indication of a respective purpose of the list of purposes and an indication of whether a user of the UE consents to the respective purpose, and transmitting, based on the request, a response including the public key, the header information, the one or more messages, and the signature.

Additionally, or alternatively, the UE 600 may support at least one memory (e.g., the memory 604) and at least one processor (e.g., the processor 602) coupled with the at least one memory and configured to cause the UE to receive a request for UC information associated with the UE, the request including a list of purposes for collecting or processing data, generate a signature based on a public key, a secret key, header information, and one or more messages including an indication of a respective purpose of the list of purposes and an indication of whether a user of the UE consents to the respective purpose, and transmit, based on the request, a response including the public key, the header information, the one or more messages, and the signature.

Additionally, the UE 600 may be configured to support any one or combination of the at least one processor configured to cause the UE 600 to generate the secret key based on a secret IKM and generate the public key based on the secret key. Additionally, the UE 600 may be configured to support any one or combination of the at least one processor configured to cause the UE 600 to display, via a GUI of the UE, the list of purposes to the user of the UE and receive, from the user, user input indicating whether the user of the UE consents to each purpose of the list of purposes. Additionally, the UE 600 may be configured to support any one or combination of the at least one processor configured to cause the UE 600 to generate the header information, where the header information includes an indication of a quantity of purposes included in the list of purposes and a time associated with generating the signature.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving, based on a request for credentials, a response including one or more messages, first header information, a public key, and a signature, the one or more messages including an indication of a respective purpose of a list of purposes for collecting or processing data, generating a proof based on a message of the one or more messages, a secret key, the signature, and second header information, the message including an indication of a respective purpose of the list of purposes that a user of the UE consents to, and transmitting a signal including the message, the second header information, and the proof.

Additionally, or alternatively, the UE 600 may support at least one memory (e.g., the memory 604) and at least one processor (e.g., the processor 602) coupled with the at least one memory and configured to cause the UE to receive, based on a request for credentials, a response including one or more messages, first header information, a public key, and a signature, the one or more messages including an indication of a respective purpose of a list of purposes for collecting or processing data, generate a proof based on a message of the one or more messages, a secret key, the signature, and second header information, the message including an indication of a respective purpose of the list of purposes that a user of the UE consents to, and transmit a signal including the message, the second header information, and the proof.

Additionally, the UE 600 may be configured to support any one or combination of the at least one processor configured to cause the UE 600 to display, via a GUI of the UE, the list of purposes to the user of the UE and receive, from the user, user input indicating whether the user of the UE consents to each purpose of the list of purposes. Additionally, the UE 600 may be configured to support any one or combination of the at least one processor configured to cause the UE 600 to compute a commitment C over the permanent subscriber ID using a hash-based commitment or a Pederson commitment.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

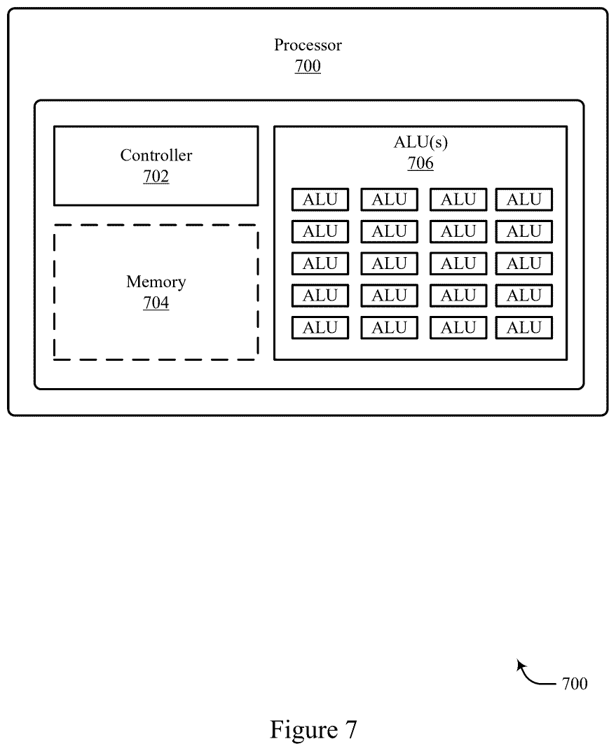

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive a request for UC information associated with the UE, the request including a list of purposes for collecting or processing data, generate a signature based on a public key, a secret key, header information, and one or more messages including an indication of a respective purpose of the list of purposes and an indication of whether a user of the UE consents to the respective purpose, and transmit, based on the request, a response including the public key, the header information, the one or more messages, and the signature.

Additionally, the processor 700 may be configured to or operable to support any one or combination of generating the secret key based on a secret IKM and generating the public key based on the secret key. Additionally, the processor 700 may be configured to or operable to support any one or combination of displaying, via a GUI of the UE, the list of purposes to the user of the UE and receiving, from the user, user input indicating whether the user of the UE consents to each purpose of the list of purposes. Additionally, the processor 700 may be configured to or operable to support any one or combination of generating the header information, where the header information includes an indication of a quantity of purposes included in the list of purposes and a time associated with generating the signature.

Moreover, the processor 700 may be configured to or operable to support at least one controller (e.g., the controller 702) coupled with at least one memory (e.g., the memory 704) and configured to cause the processor to receive, based on a request for credentials, a response including one or more messages, first header information, a public key, and a signature, the one or more messages including an indication of a respective purpose of a list of purposes for collecting or processing data, generate a proof based on a message of the one or more messages, a secret key, the signature, and second header information, the message including an indication of a respective purpose of the list of purposes that a user of the UE consents to, and transmit a signal including the message, the second header information, and the proof.

Additionally, the processor 700 may be configured to or operable to support any one or combination of displaying, via a GUI of the UE, the list of purposes to the user of the UE and receiving, from the user, user input indicating whether the user of the UE consents to each purpose of the list of purposes. Additionally, the processor 700 may be configured to or operable to support any one or combination of computing a commitment C over the permanent subscriber ID using a hash-based commitment or a Pederson commitment.

Moreover, the processor 700 may be configured to or operable to support at least one controller (e.g., the controller 702) coupled with at least one memory (e.g., the memory 704) and configured to cause the processor to transmit a request for UC information associated with a UE, the request including one or more purposes of a list of purposes for collecting or processing data, receive, based on the request, a response including one or more messages, header information, and a proof, the one or more messages including an indication of a respective purpose of the one or more purposes and an indication of whether a user of the UE consents to the respective purpose, and verify the proof based on a public key. Additionally, the processor 700 may be configured to or operable to support any one or combination of detecting that the one or more purposes require consent from the user prior to executing the one or more purposes.

Moreover, the processor 700 may be configured to or operable to support at least one controller (e.g., the controller 702) coupled with at least one memory (e.g., the memory 704) and configured to cause the processor to transmit a request for UC information associated with a UE, the request including one or more purposes for collecting or processing data, receive, based on the request, a response including one or more messages, header information, and a proof, the one or more messages including an indication of a respective purpose of a list of purposes that a user of the UE consents to, and verify the proof based on a public key.

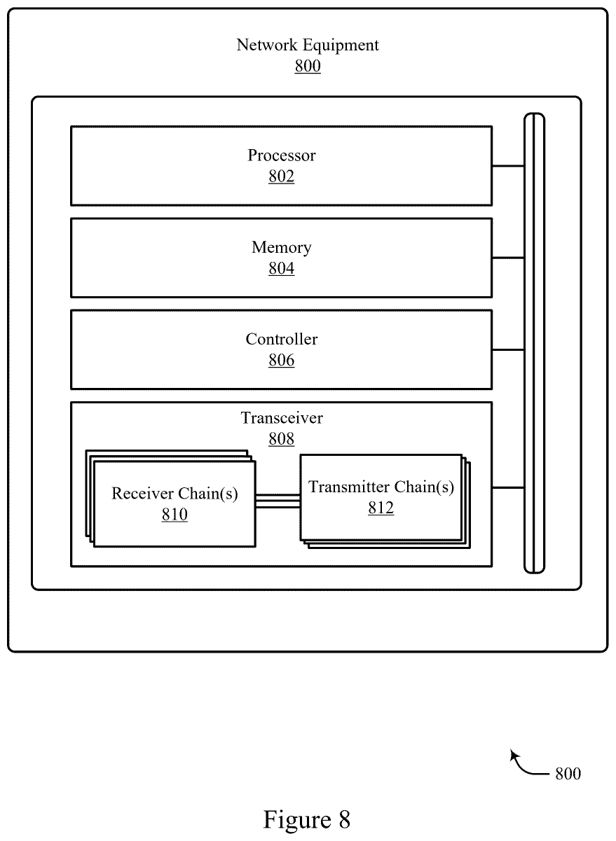

FIG. 8 illustrates an example of an NE 800 in accordance with aspects of the present disclosure. In some examples, the NE 800 may be an example of an NE or an NF service producer as described with reference to FIGS. 1 through 5. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting a request for UC information associated with a UE, the request including one or more purposes of a list of purposes for collecting or processing data, receiving, based on the request, a response including one or more messages, header information, and a proof, the one or more messages including an indication of a respective purpose of the one or more purposes and an indication of whether a user of the UE consents to the respective purpose, and verifying the proof based on a public key.

Additionally, or alternatively, the NE 800 may support at least one memory (e.g., the memory 804) and at least one processor (e.g., the processor 802) coupled with the at least one memory and configured to cause the NE to transmit a request for UC information associated with a UE, the request including one or more purposes of a list of purposes for collecting or processing data, receive, based on the request, a response including one or more messages, header information, and a proof, the one or more messages including an indication of a respective purpose of the one or more purposes and an indication of whether a user of the UE consents to the respective purpose, and verify the proof based on a public key. Additionally, the NE 800 may be configured to support any one or combination of the at least one processor configured to cause the NE 800 to detect that the one or more purposes require consent from the user prior to executing the one or more purposes.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting a request for UC information associated with a UE, the request including one or more purposes for collecting or processing data, receiving, based on the request, a response including one or more messages, header information, and a proof, the one or more messages including an indication of a respective purpose of a list of purposes that a user of the UE consents to, and verifying the proof based on a public key.

Additionally, or alternatively, the NE 800 may support at least one memory (e.g., the memory 804) and at least one processor (e.g., the processor 802) coupled with the at least one memory and configured to cause the NE to transmit a request for UC information associated with a UE, the request including one or more purposes for collecting or processing data, receive, based on the request, a response including one or more messages, header information, and a proof, the one or more messages including an indication of a respective purpose of a list of purposes that a user of the UE consents to, and verify the proof based on a public key.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

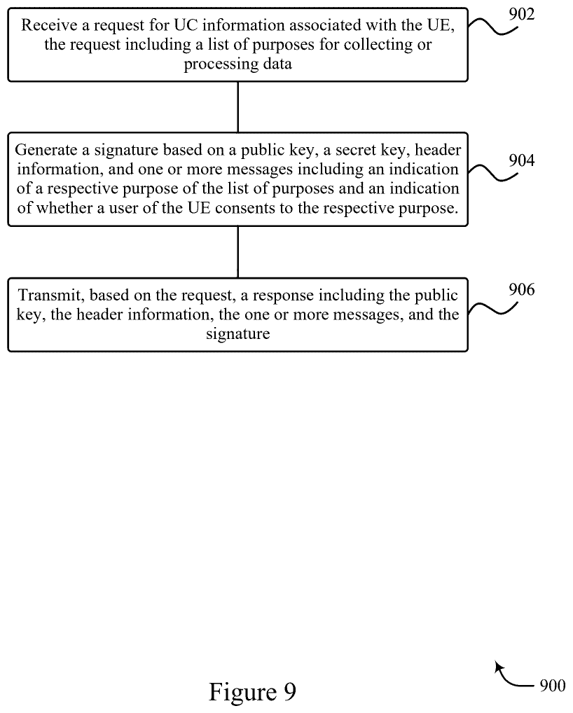

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving a request for UC information associated with the UE, the request including a list of purposes for collecting or processing data. The operations of 902 may be performed in accordance with examples as described herein. In some implementations, aspects of the operations of 902 may be performed by the UE 600 as described with reference to FIG. 6.

At 904, the method may include generating a signature based on a public key, a secret key, header information, and one or more messages including an indication of a respective purpose of the list of purposes and an indication of whether a user of the UE consents to the respective purpose. The operations of 904 may be performed in accordance with examples as described herein. In some implementations, aspects of the operations of 904 may be performed by the UE 600 as described with reference to FIG. 6.

At 906, the method may include transmitting, based on the request, a response including the public key, the header information, the one or more messages, and the signature. The operations of 906 may be performed in accordance with examples as described herein. In some implementations, aspects of the operations of 906 may be performed the UE 600 as described with reference to FIG. 6.

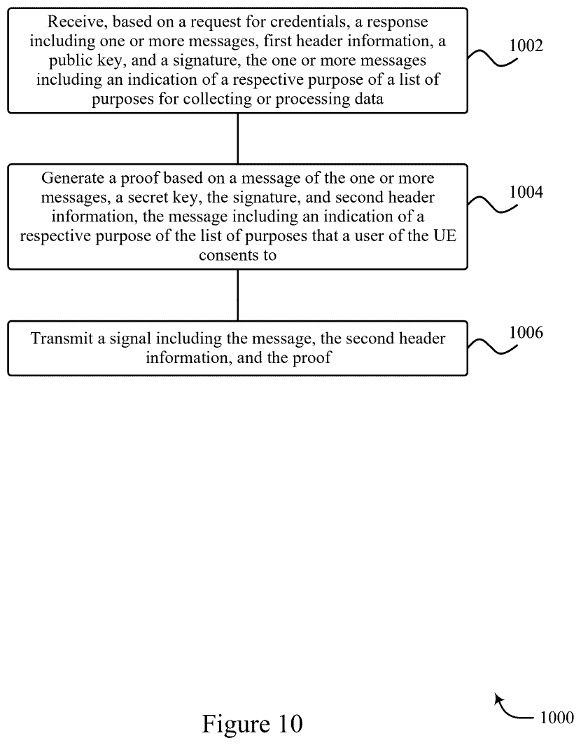

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving, based on a request for credentials, a response including one or more messages, first header information, a public key, and a signature, the one or more messages including an indication of a respective purpose of a list of purposes for collecting or processing data. The operations of 1002 may be performed in accordance with examples as described herein. In some implementations, aspects of the operations of 1002 may be performed by the UE 600 as described with reference to FIG. 6.

At 1004, the method may include generating a proof based on a message of the one or more messages, a secret key, the signature, and second header information, the message including an indication of a respective purpose of the list of purposes that a user of the UE consents to. The operations of 1004 may be performed in accordance with examples as described herein. In some implementations, aspects of the operations of 1004 may be performed by the UE 600 as described with reference to FIG. 6.

At 1006, the method may include transmitting a signal including the message, the second header information, and the proof. The operations of 1006 may be performed in accordance with examples as described herein. In some implementations, aspects of the operations of 1006 may be performed the UE 600 as described with reference to FIG. 6.

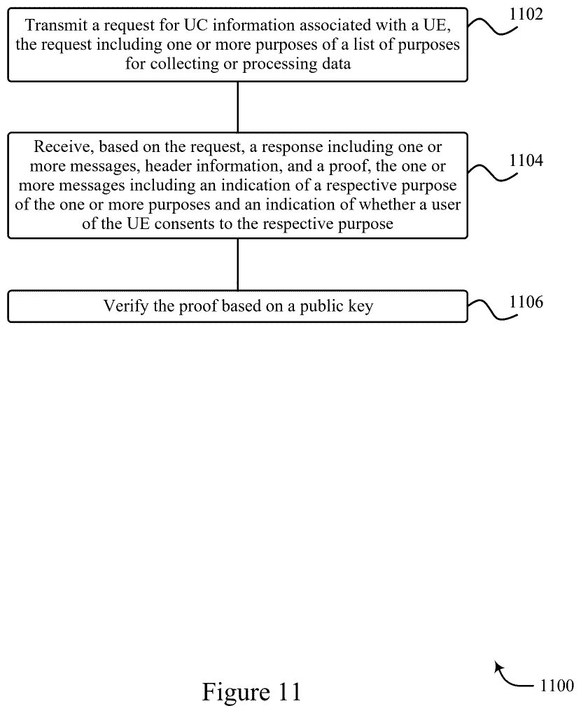

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting a request for UC information associated with a UE, the request including one or more purposes of a list of purposes for collecting or processing data. The operations of 1102 may be performed in accordance with examples as described herein. In some implementations, aspects of the operations of 1102 may be performed by the NE 800 as described with reference to FIG. 8.

At 1104, the method may include receiving, based on the request, a response including one or more messages, header information, and a proof, the one or more messages including an indication of a respective purpose of the one or more purposes and an indication of whether a user of the UE consents to the respective purpose. The operations of 1104 may be performed in accordance with examples as described herein. In some implementations, aspects of the operations of 1104 may be performed by the NE 800 as described with reference to FIG. 8.

At 1106, the method may include verifying the proof based on a public key. The operations of 1106 may be performed in accordance with examples as described herein. In some implementations, aspects of the operations of 1106 may be performed by the NE 800 as described with reference to FIG. 8.

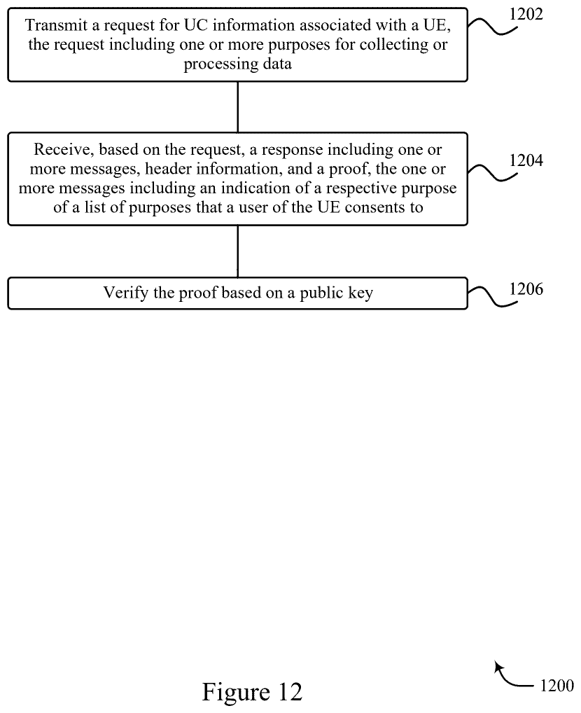

FIG. 12 illustrates a flowchart of a method 1200 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include transmitting a request for UC information associated with a UE, the request including one or more purposes for collecting or processing data. The operations of 1202 may be performed in accordance with examples as described herein. In some implementations, aspects of the operations of 1202 may be performed by the NE 800 as described with reference to FIG. 8.

At 1204, the method may include receiving, based on the request, a response including one or more messages, header information, and a proof, the one or more messages including an indication of a respective purpose of a list of purposes that a user of the UE consents to. The operations of 1204 may be performed in accordance with examples as described herein. In some implementations, aspects of the operations of 1204 may be performed by the NE 800 as described with reference to FIG. 8.

At 1206, the method may include verifying the proof based on a public key. The operations of 1206 may be performed in accordance with examples as described herein. In some implementations, aspects of the operations of 1206 may be performed by the NE 800 as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a request for user consent information associated with the UE, the request comprising a list of purposes for collecting or processing data;
generate a signature based at least in part on a public key, a secret key, header information, and one or more messages comprising an indication of a respective purpose of the list of purposes and an indication of whether a user of the UE consents to the respective purpose; and
transmit, based at least in part on the request, a response comprising the public key, the header information, the one or more messages, and the signature.

2. The UE of claim 1, wherein the at least one processor is further operable to cause the UE to:
generate the secret key based at least in part on a secret input key material (IKM); and
generate the public key based at least in part on the secret key.

3. The UE of claim 1, wherein the at least one processor is further operable to cause the UE to:
display, via a graphical user interface (GUI) of the UE, the list of purposes to the user of the UE; and
receive, from the user, user input indicating whether the user of the UE consents to each purpose of the list of purposes.

4. The UE of claim 1, wherein the at least one processor is further operable to cause the UE to:
generate the header information, wherein the header information comprises an indication of a quantity of purposes comprised in the list of purposes and a time associated with generating the signature.

5. The UE of claim 1, wherein the one or more messages further comprise an indication of a permanent subscriber identity (ID) associated with the UE.

6. The UE of claim 1, wherein the list of purposes comprises collecting or processing data for location determination, analytics, artificial intelligence (AI) model training, AI inference, location retrieval, or user information exposure.

7. A user equipment (UE) for wireless communication, comprising:
at least one memory; and
at least one processor coupled with the at least one memory and operable to cause the UE to:
receive, based at least in part on a request for credentials, a response comprising one or more messages, first header information, a public key, and a signature, the one or more messages comprising an indication of a respective purpose of a list of purposes for collecting or processing data;
generate a proof based at least in part on a message of the one or more messages, a secret key, the signature, and second header information, the message comprising an indication of a respective purpose of the list of purposes that a user of the UE consents to; and
transmit a signal comprising the message, the second header information, and the proof.

8. The UE of claim 7, wherein the at least one processor is further operable to cause the UE to:
display, via a graphical user interface (GUI) of the UE, the list of purposes to the user of the UE; and
receive, from the user, user input indicating whether the user of the UE consents to each purpose of the list of purposes.

9. The UE of claim 7, wherein the response further comprises an indication of a permanent subscriber identity (ID) associated with the UE.

10. The UE of claim 9, wherein the at least one processor is further operable to cause the UE to:
compute a commitment C over the permanent subscriber ID using a hash-based commitment or a Pederson commitment.

11. The UE of claim 10, wherein the signal further comprises the commitment C in the second header information.

12. The UE of claim 7, wherein the second header information comprises a time associated with generating the proof, a quantity of nondisclosed purposes, domain information, a quantity of purposes comprised in the list of purposes, and a time associated with generating the signature.

13. The UE of claim 7, wherein the list of purposes comprises collecting or processing data for location determination, analytics, artificial intelligence (AI) model training, AI inference, location retrieval, or user information exposure.

14. A network equipment (NE) for wireless communication, comprising:
at least one memory; and
at least one processor coupled with the at least one memory and operable to cause the NE to:
transmit a request for user consent information associated with a user equipment (UE), the request comprising one or more purposes of a list of purposes for collecting or processing data;
receive, based at least in part on the request, a response comprising one or more messages, header information, and a proof, the one or more messages comprising an indication of a respective purpose of the one or more purposes and an indication of whether a user of the UE consents to the respective purpose; and
verify the proof based at least in part on a public key.

15. The NE of claim 14, wherein the header information comprises a time associated with generating the proof, a quantity of undisclosed purposes, domain information, a quantity of purposes comprised in the list of purposes, and a time associated with generating a signature associated with the proof.

16. The NE of claim 14, wherein the request further comprises an indication of a permanent subscriber identity (ID) associated with the UE.

17. The NE of claim 14, wherein the at least one processor is further operable to cause the NE to:
detect that the one or more purposes require consent from the user prior to executing the one or more purposes.

18. A network equipment (NE) for wireless communication, comprising:
at least one memory; and
at least one processor coupled with the at least one memory and operable to cause the NE to:
transmit a request for user consent information associated with a user equipment (UE), the request comprising one or more purposes for collecting or processing data;
receive, based at least in part on the request, a response comprising one or more messages, header information, and a proof, the one or more messages comprising an indication of a respective purpose of a list of purposes that a user of the UE consents to; and
verify the proof based at least in part on a public key.

19. The NE of claim 18, wherein the header information comprises a time associated with generating the proof, a quantity of undisclosed purposes, domain information, a quantity of purposes comprised in the list of purposes, and a time associated with generating a signature associated with the proof.

20. The NE of claim 18, wherein the request further comprises an indication of a permanent subscriber identity (ID) associated with the UE.
